(19) United States
(12) Patent Application Publication
(10) Pub. No.: US 2018/0255140 A1
(43) Pub. Date: Sep. 6, 2018

(54) IOT TERMINAL APPARATUS AND METHOD FOR CONTROLLING MULTIPLE IOT DEVICES

(71) Applicant: XIAMEN ECO LIGHTING CO. LTD., Xiamen (CN)

(72) Inventors: JinHong Chen, Xiamen (CN); YuChun Ding, Xiamen (CN)

(21) Appl. No.: 15/482,362

(22) Filed: Apr. 7, 2017

(30) Foreign Application Priority Data
Mar. 2, 2017 (CN) 201710119012X

(51) Int. Cl. H04L 29/08; H04L 29/06

(52) U.S. Cl. CPC H04L 67/125; H04L 41/0836; H04L 69/28

(57) ABSTRACT

An IOT (Internet Of Things) terminal apparatus, to be able to work with other IOT devices, includes following elements. A communication circuit communicates with at least one external IOT device through a communication network. A timing module time times through the internal timing module to produce a present estimated time, and according to a predetermined rule, to obtain a time proof information from external IOT devices through the communication circuit. After obtaining the time proof information, judges whether to adjust the present estimated time calculated by the internal timing module or not, according to the predetermined rule. A processing circuit cooperates with the external IOT devices, according to the present estimation time, to complete a predetermined IOT operation.

### FIELD

The present disclosure relates to an IOT (Internet Of Things) terminal apparatus and a controlling method, and more particularly to an IOT device which may co-operate with multiple IOT devices and the controlling method.

### BACKGROUND OF INVENTION

With the progress of electronic technology and network technology, a large number of IOT devices enter into the field of life. However, before these technologies becoming popular, there are still some technical issues need to be solved. For example, although it is possible to use complex circuits to accomplish complex tasks at present, there are still a lot of latent limitations for these devices to enter the daily lives if we may not control the complexity and reduce costs.

In addition, now all the electronic equipments in the house, including television, electric lights, audio, coffee machines, refrigerators, etc., theoretically may be converted into an IOT device with the function of the IOT. However, these devices are always very different in using characteristics and using environment. For example, the lamp equipment usually needs to bear relatively high ambient temperature. At that time, even if we don't consider the cost, the elements in the inner circuit of the IOT, which are more sensitive to temperature, may be unstable because of the ambient temperature.

In particular, sometimes, these phenomena may happen for a long time, and the damage or inaccuracy may occur in an irregular and unpredictable manner. For example, a Real Time Clock circuit is set in the IOT device generally. This circuit always produces unstable timing error due to the ambient temperature. In addition, this circuit itself is also a factor in the cost of the IOT devices.

In addition, why the IOT devices may bring a comprehensive and far-reaching impact to human life, another factor is the co-operation between multiple IOT devices. However, it is often necessary to rely on an accurate synchronization timing to allow multiple IOT devices to work together. Otherwise, some lights may be turned on before the alarm ringed. Or the music and the lighting effects may not be synchronized and so on.

In addition, some IOT devices may go into a dormant state or restart due to a power failure. At this time, how to synchronize time quickly and effectively, it is also a challenging task.

### SUMMARY OF THE INVENTION

After observing the above-mentioned technical problems, the inventors of the present invention propose the following embodiments to solve some or all of the technical problems.

The first embodiment of the instant disclosure provides an IOT terminal apparatus, being able to work with other IOT devices. For example, this IOT terminal apparatus may be a light bulb, audio, television, air conditioning, refrigerators, cameras, doorbell and so on. The user may operate multiple IOT devices together to complete a co-operation. For example, the user may set as follows: 06:30 am, the coffee machine begins to cook coffee; 06:40 am, the two bulbs begin to slowly brighten; 6:50 am, the audio begins to play the radio program, and the other two bulbs begin to light. By this series co-operation in multiple IOT devices, the users may be provided with a required experience.

To make this co-operation smoothly happen, the IOT devices have to provide with a relatively accurate timing mechanism. As the above case, if all the IOT devices are simultaneously ahead of or delayed for a few minutes, the impact on the user is usually not easy to be noticed. However, if some estimated time of the IOT goes too fast, and some goes too slow, it may cause the discordance to the entire co-operation.

The IOT terminal apparatus mentioned here mainly refers to the device with function of the IOT, and is able to complete a certain operation of the IOT, belonging to a generalized IOT device. Some IOT devices may consist of a smart switch and a traditional TV.

The elements of the IOT terminal apparatus may be illustrated by the following illustration.

The communication circuit may communicate with at least one external IOT device through a communication network. The communication network may be a wired network, a wireless network, or a part wired and a part wireless network. For example, Wi-Fi, Bluetooth, Zig-Bee, Z-Wave, all may be the communication network mentioned here. The communication circuit is a software, a hardware corresponded to a circuit, which is created according to the communication network, or the combination of the two.

The timing module times through the internal timing module to estimate the present time. Here mentioned timing module may be a pure hardware circuit, may also be part hardware, part software or all carried out by the software in the corresponding circuit. According to a predetermined rule, the timing module acquires time proof information from an external IOT device through the communication circuit. After acquiring the time proof information, the timing module judges whether to adjust the estimated current time or not, wherein the estimated present time is calculated by the internal timing module based on the predetermined rule.

The processing circuit cooperates with the external IOT device, in accordance with the present estimated time, to complete a predetermined IOT operation together. The processing circuit mentioned here is based on the properties of different IOT terminal apparatus, provided with a variety of different functions. For example, for a bulb, the processing circuit may control the driving circuit to produce different driving currents and to adjust the brightness of the bulb, or further include a corresponding program. If it is the other type of IOT terminal apparatus, it may be designed as the other corresponding circuit. As for how these circuits may be designed, a considerable proportion of the technologies are already well-known by various kinds of designers, here may be not repeated again.

In addition, at present, the skilled person in the electronic technology field is able to understand that multiple circuits may be written through the corresponding program code, and executed by the corresponding circuit, to complete a predetermined content to the outside overall. This approach is a choice of design, some choices may not be considered as a purely software code because of the difference in the way of the choice, but not belong to the scope of patent protection.

By the combination of the above elements, the IOT terminal apparatus usually may time through the internal timing module. And, in particular, when it comes to cooperate with other IOT devices, the time module may adjust its present estimated time according to the time proof information of other IOT devices, which is coming from the communication network. In other words, even if the present estimated time of the internal timing module timed is incorrect, or even accurate, but inconsistent with other IOT device, the timing module may adjust its present estimated time based on the time proof information. Of course, if the present estimated time is generated directly from the time proof information, it also belongs to a type of adjusting its present estimated time.

In one embodiment, the internal timing module of the timing module may be a set of timing program code, executed by the processing circuit, and obtain the present estimated time based on the result of the execution. For example, the timing program code may include an infinite loop for the accumulation of the timing variable, and convert the value of the timing variable to the corresponding present estimated time. For example, in a calculation loop of constantly adding 1, divided the accumulative number by the corresponding units, we may know how much time passed. And then, adding the initial base time, we may get the present estimated time.

Under such a design, there is no deed for requiring an extra timing hardware circuit, which not only saves the cost, but also avoids the inaccuracy of the timing circuit caused by the environmental temperature. In other words, in one embodiment, the inner side of the IOT device may be provided without an exclusive real-time clock circuit.

In addition, in one embodiment, according to the predetermined rule, the timing module may be set as being able to receive multiple time proof information from multiple different external IOT devices. The timing module judges which the time proof information is used to adjust the present estimation time according to the predetermined rule. For example, there are total of six bulb IOT devices, scheduled to be lit at 06:00 in the morning. Each bulb is timed separately, and when individual bulbs realize the time is 05:00 based on their present estimated time, they send time proof information to other bulb IOT devices. A light bulb IOT device may be able to receive the time proof information from three light bulb IOT devices in sequence. At this time, the time proof information arrived earliest may be used as the basis for adjusting the present estimated time according to the predetermined rule, and ignore multiple other time proof information.

This predetermined rule also may set the time proof information that arrived latest as the line, or after receiving the first time proof information, all the bulb IOT devices report to the device which sent the time proof information, and stop sending their own time proof information.

In other words, this time proofing information may be a distributed style, rather than through a central style. This setting mode has a great effect on the flexibility and ease of use.

In addition, according to the predetermined rule, when the present estimated time coincides with a predetermined time, the timing module, via the communication circuit, issue the time proof information corresponded to the present estimated time to other external IOT device, and then the other external IOT device correct time after received the time proof information. In other words, each of the IOT devices may passively receive the time proof information for synchronization, or proactively issue the time proof information.

Since the speed of the information transmitted by the electronic network itself is very fast, in other words, deducting the time of processing the information, the time proof information received is almost the time proof information issued.

Therefore, if the receiver knows the sender sending the message at the time that the sender realizes the time is 05:00, the time received the information may be used as a reference for the proof time after considering the time of delivery and processing. Of course, time proof information may also be added with more information, such as the sender's information, or with the information related to the co-operation. All may be considered to be within the scope of the present invention

In addition, the processing circuit may obtain the co-operation program code through the communication circuit. The co-operation program code may define the predetermined rules and operational instructions, which are required for the co-operation between the IOT terminal apparatus and the external IOT terminal apparatus. In other words, the IOT terminal apparatus do not have to set up the control program and the behind logic when leaving the factory, the user may set according to their demands after the purchase. The co-operation program code mentioned here may be presented in the form of firmware update or parameter reception, and realized by the executable code or pseudo code. As mentioned above, under the instructions here, any skilled person may design a different co-operation program code with the corresponding format.

In addition, the co-operation program code may afford different the predetermined rules to multiple co-operated IOT devices. The predetermined rule indicates whether to the issue and the condition for issuing the time proof information to the other external IOT devices. In other words, different IOT devices may play a different role in co-operation, and the co-operation program codes may start different functions in different roles.

The co-operation program code may be generated by the local server and transmitted to the processing circuit through the communication circuit. Generally, there is a so-called local server at home or office, such as a Wi-Fi router. A server device with such a service function may be responsible for setting up and providing a co-operation program.

In some cases, the IOT devices may be restarted because of a user's shutdown or a power outage. At this time, the processing circuit may request the time proof information from the external IOT devices through the communication network, and adjust the present estimation time based on the acquired time proof information.

In one embodiment, the IOT terminal apparatus may further include a real-time timing circuit. The processing circuit may employ the present estimated time when process the co-operation between the IOT and the external IOT devices, but for other part of the operation, it may employ the estimated time corresponding to the real-time timing circuit. In addition, even if there is no real-time timing circuit, an IOT terminal apparatus may also maintain more than two of the present estimated time based on different requirements. For example, for different co-operations, maintain different present estimated times to meet the synchronization of each co-operation.

As described above, such an IOT terminal apparatus may be of various types, for example, an illumination circuit. The processing circuit may operate the illumination circuit according to the present estimated time and the predetermined rule to achieve the co-operation.

In another example, the IOT terminal apparatus may also include a sound circuit. The processing circuit may operate the sound circuit according to the present estimated time and the predetermined rule to achieve the co-operation.

In addition, in one embodiment, the processing circuit exchanges information with other external IOT devices through the communication circuit, to determine the role of the IOT terminal apparatus in the overall co-operation and the content of corresponded co-operation.

In addition, an embodiment of the present invention, at least further include a method for controlling the co-operation of multiple IOT devices, including the following steps.

Providing co-operation code for placing multiple IOT devices, wherein each of the IOT devices includes a communication circuit, a timing module and a processing circuit. The communication circuit may communicate with at least one other IOT devices through the communication network. The timing module time through the internal timing module to produce a present estimated time. According to a predetermined rule, the time proof information is acquired from other IOT devices through the communication circuit. After obtaining the time proof information, judge whether to adjust the present estimated time calculated by the internal timing module or not, according to the predetermined rule. And the processing circuit cooperates with other IOT devices, according to the present estimation time, to complete a predetermined IOT operation.

In one embodiment, the internal timing module of the timing module may be a set of timing program code, executed by the processing circuit, and obtain the present estimated time based on the result of the execution.

In one embodiment, the inner side of the IOT device may be provided without an exclusive real-time clock circuit.

In one embodiment, according to the predetermined rule, the timing module receives multiple the time proof information from multiple different the external IOT devices, the timing module judges which the time proof information is used to adjust the present estimation time according to the predetermined rule.

In one embodiment, the method further includes the co-operation program code, which may be generated by the local server and transmitted to the processing circuit through the communication circuit.

With the above-described embodiments, one or more of the above-mentioned technical problems may be solved according to different technical characteristics.

### BRIEF DESCRIPTION OF THE DRAWINGS

FIG. 1 illustrates a schematic view of the co-operation of multiple IOT devices according to the embodiment of the present disclosure.

FIG. 2 illustrates a schematic view of an IOT terminal apparatus according to the embodiment of the present disclosure.

FIG. 3 illustrates a schematic structural view of an IOT terminal apparatus according to the embodiment of the present disclosure.

FIG. 4 illustrates a flow chart of a method for controlling the co-operation of multiple IOT devices according to the embodiment of the present disclosure.

### DETAILED DESCRIPTION OF THE PREFERRED EMBODIMENTS

The first embodiment of the instant disclosure provides an IOT terminal apparatus, having the ability to work with other IOT devices. For example, the IOT terminal apparatus may be a light bulb, audio, television, air conditioning, refrigerators, cameras, doorbell and so on. The user may operate multiple IOT devices together to complete a co-operation. For example, the user may set as follows: 06:30 am, the coffee machine begins to cook coffee; 06:40 am, the two bulbs begins to slowly brighten; 6:50 am, the audio begins to play the radio program, and the other two bulbs begin to light. By this series co-operation in multiple IOT device, the users may be provided with a required experience.

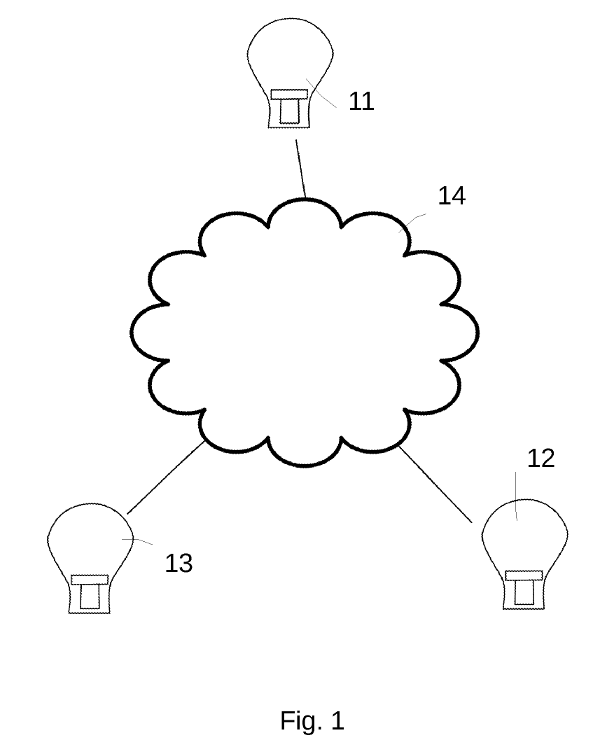

Please refer to FIG. 1. FIG. 1 illustrates a schematic view of the co-operation of multiple IOT devices according to the embodiment of the present disclosure. In FIG. 1, there are three IOT devices 11, 12, 13, communicated with each other through a wireless network 14. The three bulbs are set to be turned on at a predetermined time, turned off at a predetermined time, or turned on and turned off in a predetermined order of time, or adjusted the brightness according to a predetermined time.

To make this co-operation smoothly happened, the IOT devices have to provide with a relatively accurate timing mechanism. As the above case, if all the IOT devices are simultaneously ahead of or delayed for a few minutes, the impact on the user is usually not easy to be noticed. However, if some estimated time of the IOT is too fast, and some is too slow, it may cause the discordance to the entire co-operation.

The IOT terminal apparatus mentioned here mainly refers to the device with function of the IOT, and be able to complete a certain operation of the IOT, belonging to a generalized IOT device. Some IOT devices may consist of a smart switch and a traditional TV.

The elements of the IOT terminal apparatus may be provided and described below.

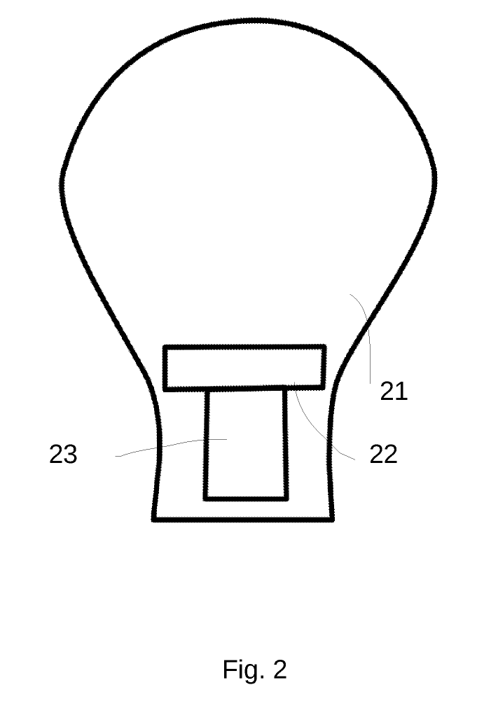

Please refer to FIG. 2. FIG. 2 illustrates a schematic view of an IOT terminal apparatus. In this embodiment, the IOT terminal apparatus itself is primarily a bulb 21. The bulb 21 includes a light source plate 22, such as an LED light source circuit board. In addition, the bulb 21 also includes a driving circuit board 23 for supplying the current required for the driving the light source plate. In addition, the circuit associated with the IOT may be provided on the drive circuit board 23.

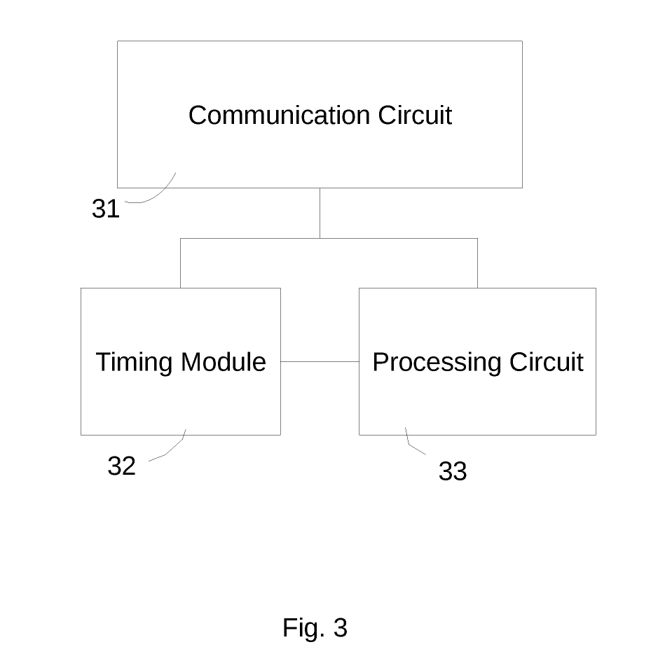

Please refer to FIG. 3. FIG. 3 illustrates a schematic structural view of an IOT terminal apparatus according to the embodiment of the present disclosure. In the embodiment of FIG. 3, the IOT terminal apparatus include a communication circuit 31, a timing module 32 and a processing circuit 33.

The communication circuit 31 may communicate with at least one external IOT device through a communication network. The communication network may be a wired network, a wireless network, or a part wired and a part wireless network. For example, Wi-Fi, Bluetooth, Zig-Bee, Z-Wave, all may be the communication network mentioned here. The communication circuit is a software, a hardware corresponded to a circuit, which is created according to the communication network, or the combination of the two.

The timing module 32 times through the internal timing module to estimate the present time. Here mentioned timing module 32 may be a pure hardware circuit, may also be part hardware, part software or all carried out by the software in the corresponding circuit. According to a predetermined rule, the timing module 32 acquires time proof information from an external IOT device through the communication circuit. After acquiring the time proof information, the timing module judges 32 whether to adjust the estimated current time or not, wherein the estimated present time is calculated by the internal timing module based on the predetermined rule.

The processing circuit 33 cooperates with the external IOT device, in accordance with the present estimated time, to complete a predetermined IOT operation together. The processing circuit 33 mentioned here is based on the properties of different IOT terminal apparatus, provided with a variety of different functions. For example, for a bulb, the processing circuit 33 may control the driving circuit to produce different driving currents to adjust the brightness of the bulb, or further include a corresponding program. If it is the other type of IOT terminal apparatus, it may be designed as the other corresponding circuit. As for how these circuits may be designed, a considerable proportion of the technologies are already well-known by various kinds of designers, here may be not repeated again.

In addition, at present, the skilled person in the electronic technology field may be able to understand that multiple circuits may be written through the corresponding program code, and executed by the corresponding circuit, to complete a predetermined content to the outside overall. This approach is a choice of design, some choices may not be considered as a purely software code because of the difference in the way of the choice, but not belong to the scope of patent protection.

By the combination of the above elements, the IOT terminal apparatus usually may time through the internal timing module. And, in particular, when it comes to cooperation with other IOT devices, the time module 32 may adjust its present estimated time according to the time proof information of other IOT devices, which is coming from the communication network. In other words, even if the present estimated time of the internal timing module timed is incorrect, or even accurate, but inconsistent with other IOT device, the timing module 32 may adjust its present estimated time based on the time proof information. Of course, if the present estimated time is generated directly from the time proof information, it also belongs to a type of adjusting its present estimated time.

In one embodiment, the internal timing module of the timing module may be a set of timing program code, executed by the processing circuit, and obtain the present estimated time based on the result of the execution. For example, the timing program code may include an infinite loop for the accumulation of the timing variable, and convert the value of the timing variable to the corresponding present estimated time. For example, in a calculation loop of constantly adding 1, divided the accumulative number by the corresponding units, we may know how much time passed. And then, added the initial base time, we may get the present estimated time.

Under such a design, there is no deed for requiring an extra timing hardware circuit, which not only saves the cost, but also avoids the inaccuracy of the timing circuit caused by the environmental temperature. In other words, in one embodiment, the inner side of the IOT device may be provided without an exclusive real-time clock circuit.

In addition, in one embodiment, according to the predetermined rule, the timing module may be set as being able to receive multiple the time proof information from multiple different the external IOT devices. The timing module judges which the time proof information is used to adjust the present estimated time according to the predetermined rule. For example, there are a total of six bulb IOT devices, scheduled to be lit at 06:00 in the morning. Each bulb is timed separately, and when individual bulbs realize the time is 05:00 based on their present estimated time, they send time proof information to other bulb IOT devices. A light bulb IOT device may be able to receive the time proof information from three light bulb IOT devices in sequence. At this time, the time proof information arrived earliest may be used as the basis for adjusting the present estimated time according to the predetermined rule, and ignore multiple other time proof information.

This predetermined rule also may set the time proof information that arrived latest as the line, or after receiving the first time proof information, all the bulb IOT devices report to the device which sent the time proof information, and stop sending their own time proof information.

In other words, this time proofing information may be a distributed style, rather than through a central style. This setting mode has a great effect on the flexibility and ease of use.

In addition, according to the predetermined rule, when the present estimated time coincides with a predetermined time, the timing module, via the communication circuit, issue the time proof information corresponded to the present estimated time to other external IOT device, and then the other external IOT device correct time after received the time proof information. In other words, each of the IOT devices may passively receive the time proof information for synchronization, or proactively issue the time proof information.

Since the speed of the information transmitted by the electronic network itself is very fast, in other words, deducting the time of processing the information, the time proof information received is almost the time the time proof information issued. Therefore, if the receiver knows the sender sends the message at the time that the sender realizes the time is 05:00, the time received the information may be used as a reference for the proof time after considering the time of delivery and processing. Of course, time proof information may also be added with more information, such as the sender's information, or with the information related to the co-operation. All may be considered to be within the scope of the present invention

In addition, the processing circuit may obtain the co-operation program code through the communication circuit. The co-operation program code may define the predetermined rules and operational instructions, which is required for the co-operation between the IOT terminal apparatus and the external IOT terminal apparatus. In other words, the IOT terminal apparatus do not have to set up the control program and the behind logic when leaving the factory, the user may set according to their demands after the purchase. The co-operation program code mentioned here may be presented in the form of firmware update or parameter reception, and realized by the executable code or pseudo code. As mentioned above, under the instructions here, any skilled person may design a different co-operation program code with the corresponding format.

In addition, the co-operation program code may afford different the predetermined rules to multiple co-operated IOT devices. The predetermined rule indicates whether to the issue and the condition for issuing the time proof information to the other external IOT devices. In other words, different IOT devices may play a different role in co-operation, and the co-operation program codes may start different functions in different roles.

The co-operation program code may be generated by the local server and transmitted to the processing circuit through the communication circuit. Generally, there is a so-called local server at home or office, such as a Wi-Fi router. A server device with such a service function may be responsible for setting up and providing a co-operation program.

In some cases, the IOT devices may be restarted because of a user's shutdown or a power outage. At this time, the processing circuit may request the time proof information from the external IOT devices through the communication network, and adjust the present estimation time based on the acquired time proof information.

In one embodiment, the IOT terminal apparatus may further include a real-time timing circuit. The processing circuit may employ the present estimated time when process the co-operation between the IOT and the external IOT devices, but for other part of the operation, it may employ the estimated time corresponding to the real-time timing circuit. In addition, even if there is no real-time timing circuit, an IOT terminal apparatus may also maintain more than two of the present estimated time based on different requirements. For example, for different co-operations, maintain different present estimated times to meet the synchronization of each co-operation.

As described above, such an IOT terminal apparatus may be of various types, for example, an illumination circuit. The processing circuit may operate the illumination circuit according to the present estimated time and the predetermined rule to achieve the co-operation.

In another example, the IOT terminal apparatus may also include a sound circuit. The processing circuit may operate the sound circuit according to the present estimated time and the predetermined rule to achieve the co-operation.

In addition, in one embodiment, the processing circuit exchanges information with other external IOT devices through the communication circuit, to determine the role of the IOT terminal apparatus in the overall co-operation and the content of corresponded co-operation.

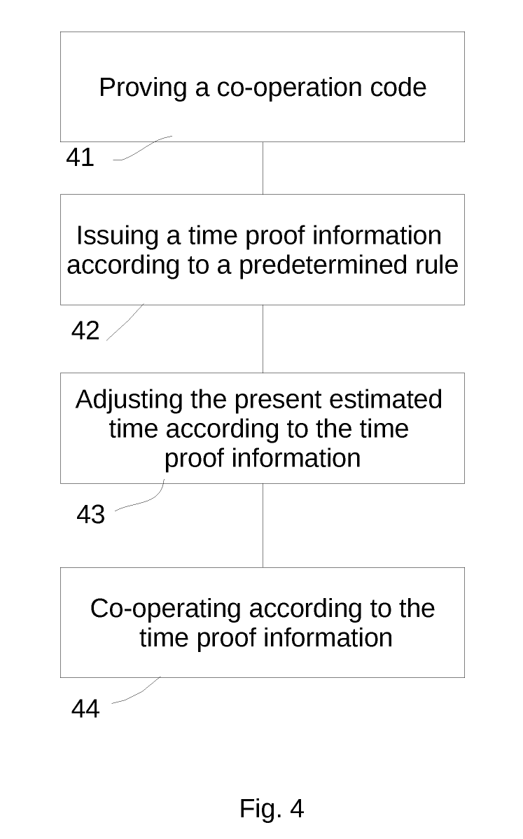

Please refer to FIG. 4. FIG. 4 illustrates a method for controlling the co-operation of multiple IOT devices, including the following steps.

Providing a co-operation code (step 41) for placing multiple IOT devices, wherein each of the IOT devices includes a communication circuit, a timing module and a processing circuit. The communication circuit may communicate with at least one other IOT devices through the communication network. The timing module time through the internal timing module to produce a present estimated time. According to a predetermined rule, one or all of the IOT devices issue time proof information (step 42). After obtaining the time proof information (step 43), judge whether to adjust the present estimated time calculated by the internal timing module or not (step 44), according to the predetermined rule. And the processing circuit cooperates with other IOT devices, according to the present estimation time, to complete a predetermined the IOT operation.

In one embodiment, the internal timing module of the timing module may be a set of timing program code, executed by the processing circuit, and obtain the present estimated time based on the result of the execution.

In one embodiment, the inner side of the IOT device may be provided without an exclusive real-time clock circuit.

In one embodiment, according to the predetermined rule, the timing module receives multiple time proof information from multiple different the external IOT devices, the timing module judges which the time proof information is used to adjust the present estimated time according to the predetermined rule.

In one embodiment, the method further includes the co-operation program code, which may be generated by the local server and transmitted to the processing circuit through the communication circuit.

With the above-described embodiments, one or more of the above-mentioned technical problems may be solved according to different technical characteristics.

While the present invention has been described with respect to the embodiments described above, those skilled in the art may be able to make appropriate substitutions or modifications in accordance with the foregoing description, including eliminating one element or adding elements, all may fall within the scope of the present invention.

1. An IOT terminal apparatus for working with other IOT devices, comprising:
a communication circuit, communicating with at least one external IOT device through a communication network;
a timing module, through the internal timing module producing a present estimated time, and according to a predetermined rule, obtaining a time proof information from the at least one external device through the communication circuit, after obtaining the time proof information, judging whether to adjust the present estimated time calculated by the internal timing module or not, according to the predetermined rule; and
a processing circuit, cooperating with the at least one external device, according to the present estimation time, completing a predetermined operation.

2. The IOT terminal apparatus of claim 1, wherein the timing module is a set of timing program code to be executed by the processing circuit, and obtaining the present estimated time based on the result of the execution.

3. The IOT terminal apparatus of claim 2, wherein the timing program code comprises an infinite loop for the accumulation of the timing variable, and converts the value of the timing variable to the corresponding present estimated time.

4. The IOT terminal apparatus of claim 2, wherein an inner side of the IOT device is provided without an exclusive real-time clock circuit.

5. The IOT terminal apparatus of claim 1, wherein according to the predetermined rule, the timing module receives a plurality of the time proof information from a plurality of different external IOT devices, and the timing module judges which the time proof information is used to adjust the present estimated time according to the predetermined rule.

6. The IOT terminal apparatus of claim 1, wherein according to the predetermined rule, the present estimated time coincides with a predetermined time, the timing module via the communication circuit issues the time proof information corresponded to the present estimated time to other external IOT device, and then the other external IOT device corrects time after receiving the time proof information.

7. The IOT terminal apparatus of claim 1, wherein the processing circuit obtains the co-operation program code through the communication circuit, and the co-operation program code defines the predetermined rules and operational instructions is required for the co-operation between the IOT terminal apparatus and the external IOT terminal apparatus.

8. The IOT terminal apparatus of claim 7, wherein the co-operation program code affords different predetermined rules to a plurality of the co-operated IOT devices, and the predetermined rule indicates whether timing module issues the time proof information to the other external IOT devices according to the condition.

9. The IOT terminal apparatus of claim 7, wherein the co-operation program code is generated by the local server and transmitted to the processing circuit through the communication circuit.

10. The IOT terminal apparatus of claim 1, wherein according to the predetermined rule, the IOT terminal apparatus is restarted, the processing circuit requests the time proof information from the external IOT devices through the communication network, and adjusts the present estimated time based on the acquired time proof information.

11. The IOT terminal apparatus of claim 1, further comprising a real-time timing circuit, wherein the processing circuit employs the present estimated time when processing the co-operation between the IOT and the external IOT devices, but for other part of the operation, the processing circuit employs the estimated time corresponding to the real-time timing circuit.

12. The IOT terminal apparatus of claim 1, wherein the communication network is a wireless network.

13. The IOT terminal apparatus of claim 1, further comprising an illumination circuit, wherein the processing circuit operates the illumination circuit according to the present estimated time and the predetermined rule to achieve the co-operation.

14. The IOT terminal apparatus of claim 1, further comprising a sound circuit, wherein the processing circuit operates the sound circuit according to the present estimated time and the predetermined rule to achieve the co-operation.

15. The IOT terminal apparatus of claim 1, wherein the processing circuit exchanges information with other external IOT devices through the communication circuit to determine the role of the IOT terminal apparatus in the overall co-operation and the content of corresponded co-operation.

16. A method for controlling the co-operation of a plurality of IOT devices, comprising:
providing a co-operation code for placing a plurality of IOT devices, wherein each of the IOT devices comprises a communication circuit, a timing module and a processing circuit, and the communication circuit is capable of communicating with at least another IOT devices through the communication network, the timing module times through the internal timing module to produce a present estimated time, according to a predetermined rule, acquiring the time proof information from other IOT devices through the communication circuit, after obtaining the time proof information, judging whether to adjust the present estimated time calculated by the internal timing module or not, according to the predetermined rule, the processing circuit cooperated with other IOT devices, according to the present estimation time, completing a predetermined the IOT operation.

17. The method for controlling the co-operation of a plurality of IOT devices of claim 16, wherein the timing module is a set of timing program code, to be executed by the processing circuit, and obtaining the present estimated time based on the result of the execution.

18. The method for controlling the co-operation of a plurality of IOT devices of claim 16, wherein an inner side of the IOT device is provided without an exclusive real-time clock circuit.

19. The method for controlling the co-operation of a plurality of IOT devices of claim 16, wherein according to the predetermined rule, the timing module receives a plurality of the time proof information from a plurality of different the external IOT devices, and the timing module judges which the time proof information is used to adjust the present estimated time according to the predetermined rule.

20. The method for controlling the co-operation of a plurality of IOT devices of claim 16, further comprising a co-operation program code generated by the local server and transmitted to the processing circuit through the communication circuit.
